(19) United States
(12) Patent Application Publication
(10) Pub. No.: US 2015/0112760 A1
(43) Pub. Date: Apr. 23, 2015

(54) Website Visitor to Phone Call Tracking System

(71) Applicants: Kenneth Bron McCall, Fruit Heights, UT (US); Scott Brady Jensen, Sandy, UT (US)

(72) Inventors: Kenneth Bron McCall, Fruit Heights, UT (US); Scott Brady Jensen, Sandy, UT (US)

(21) Appl. No.: 14/516,509

(22) Filed: Oct. 16, 2014

Related U.S. Application Data
(60) Provisional application No. 61/892,074, filed on Oct. 17, 2013.

(51) Int. Cl. G06Q 30/02; G06F 17/30

(52) U.S. Cl. CPC G06Q 30/0201; G06F 17/30592
USPC 705/7.29

(57) ABSTRACT

A website visitor tracking method includes receiving a request from a user device to view a webpage. With this request a unique visitor ID is assigned. A unique phone number is assigned to this visitor session. Returning the webpage to the website visitor, including the unique phone number to the user device. When a phone call is placed and received from this unique phone number the call and the visitor session can be associated together along with all other historical website visits of the visitor.

### BACKGROUND OF THE INVENTION

1. Field of the Invention

The present invention relates generally to marketing methodology and managing online visitor behavior with off-line customer behavior. More specifically, the present invention relates to systems and methods for tracking website visitors whom then place a phone call to obtain more information about what they have seen on the website. This invention provides a mechanism to attribute these visitor/callers back to the website visit.

2. The Relevant Technology

This process utilizes industry standard web development technologies, customer relationship management (CRM) systems, relational database management systems (RDMS), and automatic call distributor (ACD) systems to determine and generate metrics for a better understanding of how the visitor/caller first came to the website, the visitor/caller's behavior on the website, and factors or subjects that prompted the visitor/caller to call.

Known technologies do not have the functionality that provides attribution of visitor/callers to website visits.

By unifying and creating real-time communication channels between various systems, these systems work together to provide functionality that does not exist individually. This overall functionality and its core components that provide that functionality will be referred to as a Visitor Tracking System (sometimes referred to as a “VTS”).

### BRIEF SUMMARY OF THE INVENTION

The present invention has been developed in response to the present state of the art, and in particular, in response to the problems and needs in the art that have not yet been fully solved by currently available solutions.

The exemplary embodiments of the present invention allow a website visitor to be tracked and followed on through to a phone call to a call center. This tracking is accomplished by assigning a unique phone number to each website visitor and displaying that unique number to that visitor on the various webpages of the website for the duration of the visitor's visit. If the visitor then decides to place a call to the unique phone number, the visitor/caller will be directed to the company's call center or a call center communicating with the company's VTS, to get more information or take action on what they have seen on the website. The visitor/caller's call can be attributed back to the website visit and all of the visitor's actions on the website leading up to and after the phone call. The information attributed to the website visit and the accompanying call is valuable to marketing methodology and managing online visitor behavior with off-line customer behavior. Metrics can be generated from the information that the system user can use to better understand how visitors use the website, what influences visitors to call, what may not influence visitors to call, and many other marketing-pertinent issues.

For example, the exemplary embodiments of the VTS give insight and knowledge to a company's marketing and management team to better understand which marketing campaigns are their most successful marketing campaigns, at what point or points on the website do website visitors place phone calls to the company, and what effect do changes to the website have on the number of phone calls placed to the company. Also, the exemplary embodiments of the VTS allow the company to better serve a potential customer (visitor/caller) by being able to route the visitor/caller's call to the appropriate agent based upon the webpage on the website the visitor/caller is calling from, thus, eliminating annoying call transfers for the visitor/caller.

These and other features of the exemplary embodiments of the VTS of the present invention will become more fully apparent from the following description, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic component diagram showing an exemplary Visitor Tracking System (VTS) embodiment comprising a core server and a data warehouse and the connections between various components;

FIG. 2 is a schematic component diagram showing an exemplary VTS embodiment comprising a core server and a data warehouse and the connections between various components, including a Report Tools component;

FIG. 3 is a schematic component diagram showing an alternative exemplary VTS embodiment comprising a core server and a data warehouse and the connections between various components, including a Report Tools component and direct communication between the core server and a Website Analytics Server;

FIG. 4 is a schematic component diagram showing yet another exemplary VTS embodiment comprising a core server with an internal data warehouse and the connections between various components, including a Report Tools component;

FIG. 5 is a schematic component diagram showing still another exemplary VTS embodiment comprising a core server with internal data warehouse and Report Tools components and the connections between various components;

FIG. 6 is a schematic component diagram showing another alternative exemplary VTS embodiment comprising a core server, a data warehouse and a website analytics server and the connections between various components;

FIG. 7 is a schematic component diagram showing yet another alternative exemplary VTS embodiment comprising a core server, a data warehouse, an ACD System, and a CRM System and the connections between various components;

FIG. 8 is a schematic component diagram showing still another alternative exemplary VTS embodiment comprising a core server, a data warehouse, a website analytics server, an ACD System, and a CRM System and the connections between various components;

FIG. 9 is a process flow chart of an online visitor that requests a webpage that communicates with a VTS;

FIG. 10 is a process flow chart of a visitor call from an online visitor that visits a webpage that communicates with a VTS;

FIG. 11 is a data flow diagram depicting where data flows from to a data warehouse.

### DETAILED DESCRIPTION OF THE INVENTION

The exemplary embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the figures, is not intended to limit the scope of the invention, as claimed, but is merely representative of exemplary embodiments of the invention.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

As used herein, the term “Visitor Tracking System” (sometimes “VTS”) comprises one or more components that, operating together, track an online visitor from a website visit to a call to a uniquely assigned phone number so that call activity can be attributed to a specific online visitor. The Visitor Tracking System may be configured into several different embodiments, some of which are discussed specifically below as exemplary embodiments. Of course, the described, exemplary embodiments are to be considered in all respects only as illustrative, and not restrictive. The scope of the invention and its various embodiments is, therefore, indicated by the appended claims, rather than by the description. Some embodiments introduce a component or components that do not appear in the drawings of other embodiments. It should be understood that the absence or inclusion of a component with respect to an embodiment, unless specifically noted as an intended absence or inclusion, do not preclude the component from being added or removed to manifest another contemplated embodiment of the present invention.

As used herein, the term “visitor” is a person who visits a website and may or may not navigate the website. The person who is a “visitor” becomes a “visitor/caller” if that person makes a phone call to a number depicted on the website either during that person's visit to the website or after the website visit has concluded. A visitor may or may not be an existing customer of the business entity that operates the website. If the visitor is not an existing customer, the visitor may be considered to be a potential customer at some point during or after the visit.

As used herein, the term “system user” is a person or company that operates the Visitor Tracking System or is under the direct or indirect control of the person or company that operates the Visitor Tracking System. For example, a company that operates a VTS is a system user and an employee of that company who requests reports from the VTS is also a system user.

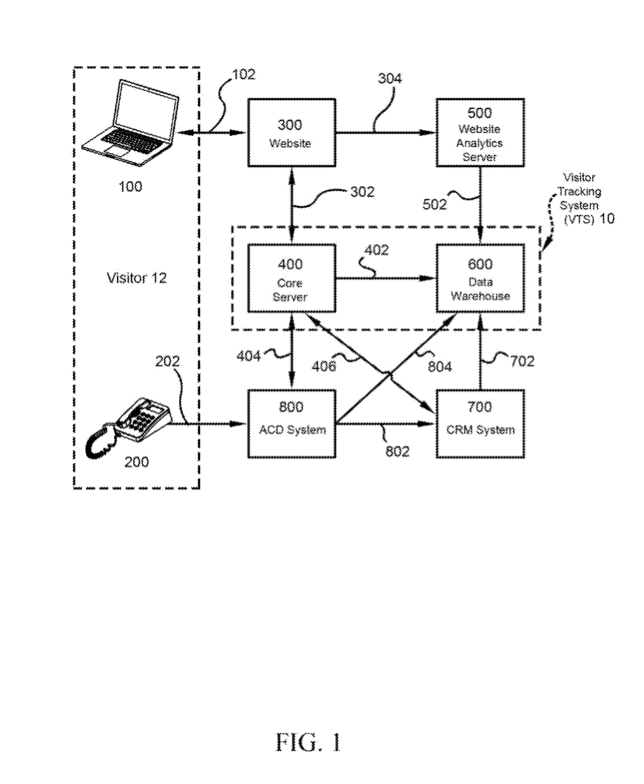

FIG. 1 is a diagram of the major system components of an exemplary Visitor Tracking System (VTS) 10 and the various interactions between these system components. A visitor's web interfacing device 100 is used by a visitor 12 to access the internet and an exemplary website 300. The visitor's web interfacing device 100 may be any of a number of devices such as a desktop computer, a laptop, a tablet, a mobile phone, or the like. In this exemplary embodiment, the visitor's web interfacing device is depicted as a laptop. A visitor's calling device 200 may be used by the visitor/caller 12 to place a phone call. The visitor's calling device 200 may be any of a number of devices such as a mobile phone, a land line telephone, a voice over the internet device, or the like. In this exemplary embodiment, the visitor's calling device is depicted as a land line telephone. The visitor 12 communicates and/or interacts with the VTS 10 using one or more of, either web interfacing devices 100 or calling devices 200.

With this exemplary embodiment, the VTS 10 comprises a core server 400 and a data warehouse 600 and depicted by the broken-line box that envelops the core server 400 and the data warehouse 600. As depicted, with the exemplary embodiment of FIG. 1, a system user (not shown) controls the VTS 10 while other components such as the website 300, a website analytics server 500, a CRM system 700, and an ACD system 800 may be controlled by a third party. However, the VTS 10 interfaces with the website 300, the website analytics server 500, the CRM system 700, and the ACD system 800 to perform the visitor tracking capabilities of the VTS 10.

The exemplary website 300 that visitors 12 access to obtain information of interest to the visitor 12 is accessible using any of the web interfacing devices 100. The website 300 communicates with the core server 400 and the website analytics server 500. The core server 400 serves as a hub for real-time communications between the various components to exchange and log data and to follow the visitor 12 during and throughout the visitor's life cycle of interaction with the VTS 10. The web analytics system 500 records website visitor actions and communicates with the data warehouse 600, passing information regarding the visitor's visit to the website 300. The data warehouse 600 receives data from the various components and uses relational database management systems (RDMS) to combine the data for further data correlations and insight.

The Customer Relationship Management (CRM) system 700 operates similar to systems typically used by call center agents to service calls from current or potential customers. The CRM system 700 receives information from the core server 400 and sends data to the data warehouse 600. The automatic call distributor (ACD) system 800 operates similar to systems typically used by a call center to initially handle and route calls to appropriate agents. The ACD system 800 sends calls to the CRM system 700 based on information received from the core server 400. For example, the ACD system 800 receives information from the core server 400 that assists the ACD system 800 to send appropriate information to the CRM system 700 so that the visitor/caller's call is directed to an agent mostly likely able to appropriately respond to the visitor/caller's inquiries. The ACD system 800 may also send data to the data warehouse 600 for combination and correlation with other data received from other components.

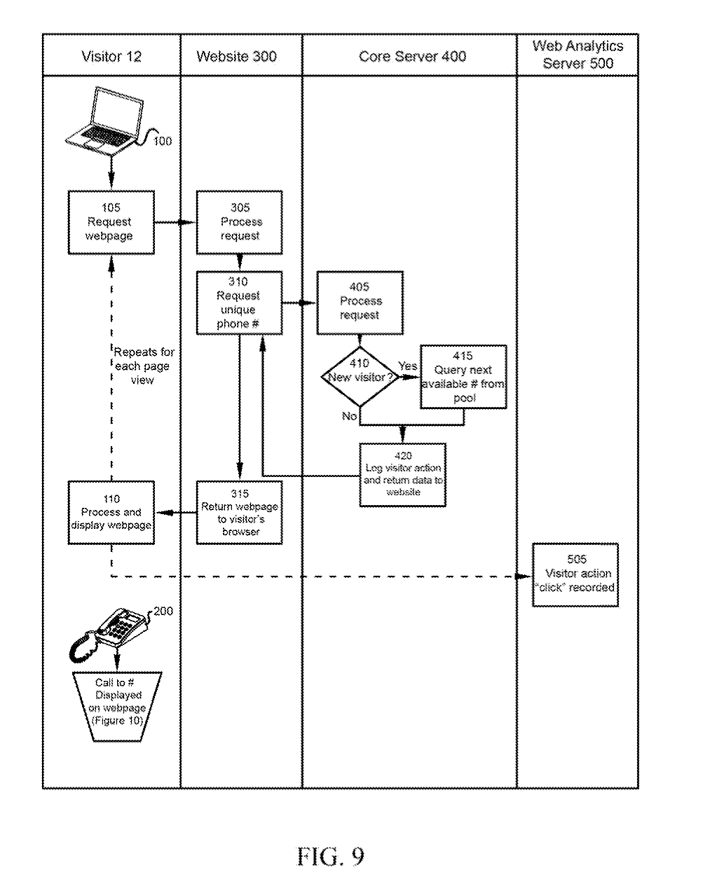

It should be understood that the website has an integration code (not shown) within the website 300 that facilitates the communication with the core server 400. As depicted, communication arrow 302 is a two-way arrow depicting that information is sent from and received by the website 300 (using the integration code) to and from the core server 400. The information sent is processed by the core server 400 (see FIG. 9) so that a unique phone number can be sent to the webpage 300 for display on the visitor's interfacing device 100. Of course, it should be understood that other information may be exchanged between the website 300 and the core server 400 to facilitate the operation of the VTS 10. Communication arrow 102 is a two-way arrow depicting an interactive exchange of information between the visitor 12 via the visitor's interfacing device 100 and the website 300 as the visitor 12 navigates the website 300 to view one or more webpages. Communication arrow 304 is a one-way arrow depicting that information is sent from the website to the web analytics server 500. Of course, in some embodiments, communication arrow 304 may be a two-way arrow indicating that there may be an exchange of information between the website 300 and the web analytics server 500.

Communication arrow 502 is a one-way arrow depicting that information is sent from the web analytics server 500 to the data warehouse 600. Of course, in some embodiments, communication arrow 502 may be a two-way arrow indicating that there may be an exchange of information between the data warehouse 600 and the web analytics server 500.

Communication arrow 402 is a one-way arrow depicting that information is sent from the core server 400 to the data warehouse 600. Of course, in some embodiments, communication arrow 402 may be a two-way arrow indicating that there may be an exchange of information between the data warehouse 600 and the core server 400.

Communication arrow 404 is a two-way arrow depicting that information is exchanged between the core server 400 and the ACD system 800. Of course, in some embodiments, communication arrow 404 may be a one-way arrow indicating that information is either sent to or receive from the core server 400 or the ACD system 800, depending on the direction of the arrow.

Communication arrow 406 is a two-way arrow depicting that information is exchanged between the core server 400 and the CRM system 700. Of course, in some embodiments, communication arrow 404 may be a one-way arrow indicating that information is either sent to or receive from the core server 400 or the CRM system 700, depending on the direction of the arrow.

Communication arrow 702 is a one-way arrow depicting that information is sent from the CRM system 700 to the data warehouse 600. Of course, in some embodiments, communication arrow 702 may be a two-way arrow indicating that there may be an exchange of information between the data warehouse 600 and the CRM system 700.

Communication arrow 802 is a one-way arrow depicting that information is sent from the ACD system 800 to the CRM system 700. Of course, in some embodiments, communication arrow 802 may be a two-way arrow indicating that there may be an exchange of information between the ACD system 800 and the CRM system 700.

Communication arrow 804 is a one-way arrow depicting that information is sent from the ACD system 800 to the data warehouse 600. Of course, in some embodiments, communication arrow 804 may be a two-way arrow indicating that there may be an exchange of information between the ACD system 800 and the data warehouse 600.

Communication arrow 202 is a one-way arrow depicting that a call is directed from the visitor's calling device 200 to the ACD system 800. In this instance, the call is placed by visitor 12 using the unique phone number displayed on the website 300.

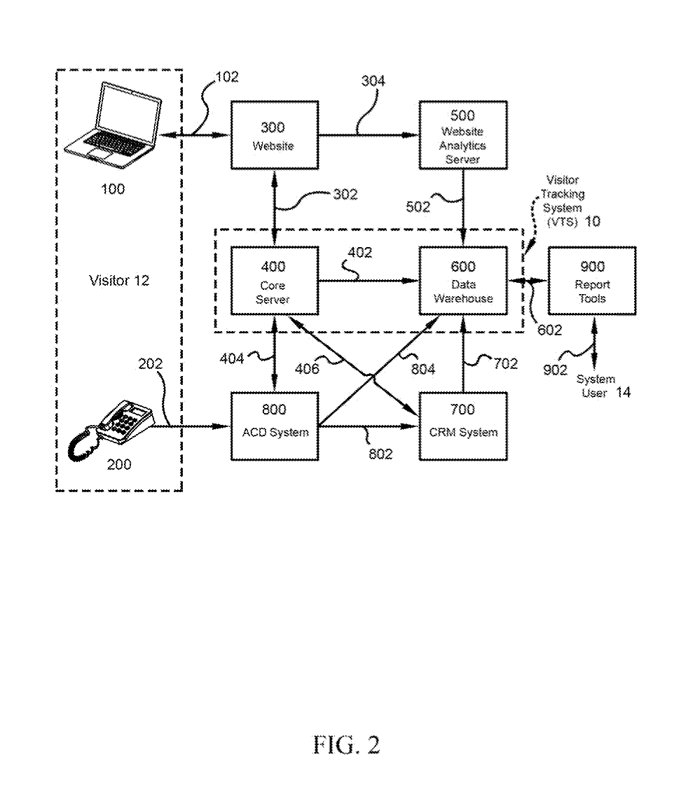

FIG. 2 is a diagram of the major system components of the exemplary Visitor Tracking System (VTS) 10 of FIG. 1 showing the various interactions between these system components, and also showing a report tools 900 component that communicates with the data warehouse 600. Again, visitor's web interfacing device 100 is used by a visitor 12 to access the internet and an exemplary website 300. A visitor's calling device 200 may be used by the visitor/caller 12 to place a phone call. The visitor 12 communicates and/or interacts with the VTS 10 using one or more of, either web interfacing devices 100 or calling devices 200.

With this exemplary embodiment, the VTS 10 comprises a core server 400 and a data warehouse 600 and depicted by the broken-line box that envelops the core server 400 and the data warehouse 600. As with the exemplary embodiment of FIG. 1, a system user 14 who controls the VTS 10, may inquire of the report tools 900 component to obtain metrics gathered and processed by the data warehouse 600 and the core server 400 of the VTS 10, while other components such as the website 300, a website analytics server 500, a CRM system 700, and an ACD system 800 may be controlled by a third party. The VTS 10 interfaces with the website 300, the website analytics server 500, the CRM system 700, and the ACD system 800 to perform the visitor tracking capabilities of the VTS 10 and the report tools component may provide the system user 14 with the metrics regarding the visitor tracking in a report format according to what type of report or reports the system user 14 requests.

The exemplary website 300 that visitors 12 access to obtain information of interest to the visitor 12 is accessible using any of the web interfacing devices 100. The website 300 communicates with the core server 400 and the website analytics server 500. The core server 400 serves as a hub for real-time communications between the various components to exchange and log data and to follow the visitor 12 during and throughout the visitor's life cycle of interaction with the VTS 10. The web analytics system 500 records website visitor actions and communicates with the data warehouse 600, passing information regarding the visitor's visit to the website 300. The data warehouse 600 receives data from the various components and uses relational database management systems (RDMS) to combine the data for further data correlations and insight.

The Customer Relationship Management (CRM) system 700 operates similar to systems typically used by call center agents to service calls from current or potential customers. The CRM system 700 receives information from the core server 400 and sends data to the data warehouse 600. The automatic call distributor (ACD) system 800 operates similar to systems typically used by a call center to initially handle and route calls to appropriate agents. The ACD system 800 sends calls to the CRM system 700 based on information received from the core server 400. For example, the ACD system 800 receives information from the core server 400 that assists the ACD system 800 to send appropriate information to the CRM system 700 so that the visitor/caller's call is directed to an agent mostly likely able to appropriately respond to the visitor/caller's inquiries. The ACD system 800 may also send data to the data warehouse 600 for combination and correlation with other data received from other components.

Communication arrow 602 is a two-way arrow depicting that information is exchanged between the data warehouse 600 and the report tools 900 component. The report tools 900 component requests information from the data warehouse 600, such information relates to the data received from the various components and results from the combination of the data by the relational database management systems (RDMS) for further data correlations and insight.

Communication arrow 902 is a two-way arrow depicting that information is exchanged between the report tools 900 component and the system user 14. The system user 14 requests either pre-formatted reports or custom reports from the report tools 900 component. The report tools 900 component then requests the information from the data warehouse 600 to populate the reports requested. The reports available from the report tools 900 component may contain information not heretofore available from any of the system components alone or in any combination known to date. Hence, the VTS 10 can provide information to determine and generate metrics for a better understanding of how the visitor/caller first came to the website, the visitor/caller's behavior on the website, and factors or subjects that prompted the visitor/caller to call.

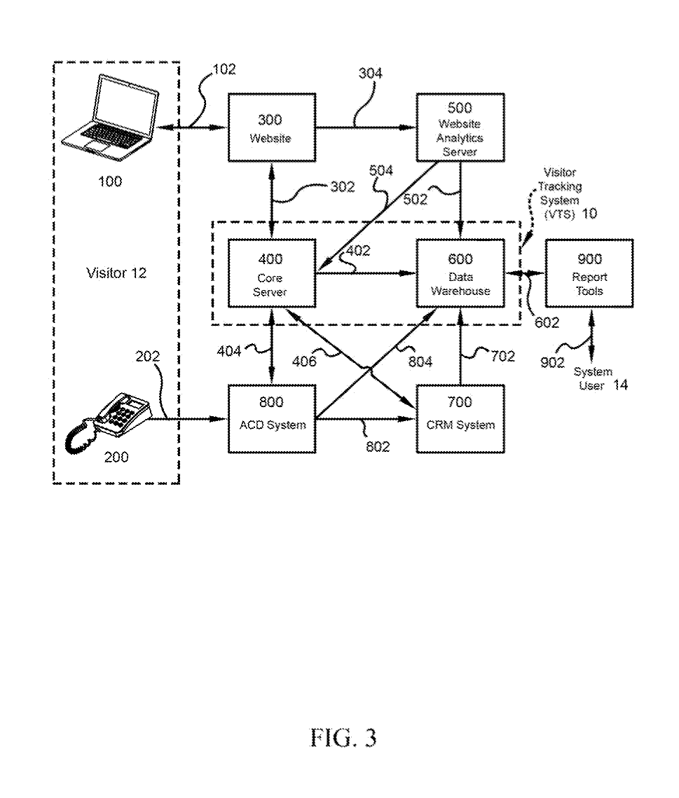

FIG. 3 is a diagram of the major system components of the exemplary Visitor Tracking System (VTS) 10 of FIG. 2 showing the various interactions between these system components, and differing only in that a communication arrow 504 extends from the website analytics server 500 to the core server 400. Again, visitor's web interfacing device 100 is used by a visitor 12 to access the internet and an exemplary website 300. A visitor's calling device 200 may be used by the visitor/caller 12 to place a phone call. The visitor 12 communicates and/or interacts with the VTS 10 using one or more of, either web interfacing devices 100 or calling devices 200.

Communication arrow 504 is a one-way arrow depicting that information is sent from the website analytics server 500 directly to the core server 400. This exemplary embodiment is provided as an example to illustrate that the flow of information between components in numerous ways that, in the interest of brevity, may not be illustrated. For another example, though not shown, a communication arrow could send information directly from the website 300 to the data warehouse 600. Of course, in some embodiments, communication arrow 504 may be a two-way arrow indicating that there may be an exchange of information between the website analytics server 500 and the core server 400. Such two-way exchange of information is also contemplated herein for other communication paths (such as between the website 300 and the data warehouse 600 mentioned above) that are not shown in the interest of brevity.

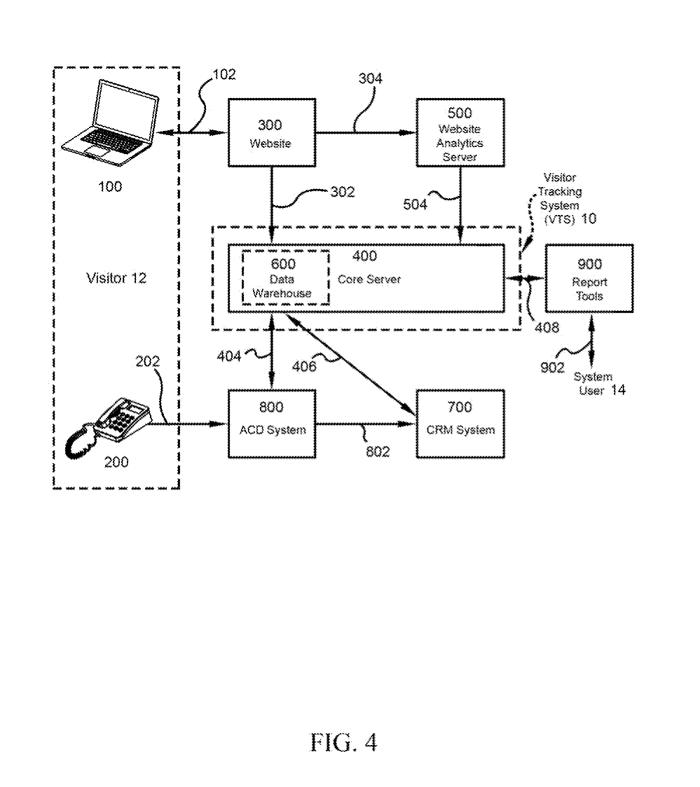

FIG. 4 is again a diagram of the major system components of an alternative exemplary Visitor Tracking System (VTS) 10 with a slightly different configuration than shown in of FIGS. 1-3. The VTS 10 of this embodiment has the data warehouse 600 disposed internal to the core server 400. Hence, each of the external system components, the website 300, the website analytics server 500, the CRM system 700, the ACD system 800, and the report tools 900 component communicate directly with the core server 400, and all communications between the core server 400 and the data warehouse 600 are handled internally within the core server 400. As shown, the core server 400 communicates directly with the report tools 900 component. Like with the previously described embodiments, visitor's web interfacing device 100 is used by a visitor 12 to access the internet and the exemplary website 300, and the visitor's calling device 200 may be used by the visitor/caller 12 to place a phone call. The visitor 12 communicates and/or interacts with this embodiment of the VTS 10 using one or more of, either web interfacing devices 100 or calling devices 200.

Communication arrow 408 is a two-way arrow depicting that information is exchanged between the core server 400 and the report tools 900 component in a manner similar to what is described with respect to communication arrow 602 in FIGS. 2 and 3. This exemplary embodiment is provided as an example to illustrate a differing configuration for the VTS 10. As shown in FIG. 4, communication arrows 302, 304, and 504 are each one-way arrows depicting the flow of information from the respective component to the core server 400. It should be understood, however, that without departing from the spirit or scope of the invention, it is contemplated that one or more of communication arrows 302, 304, and 504 may be two-way arrows depicting the exchange of information between the core server 400 and the respective external components.

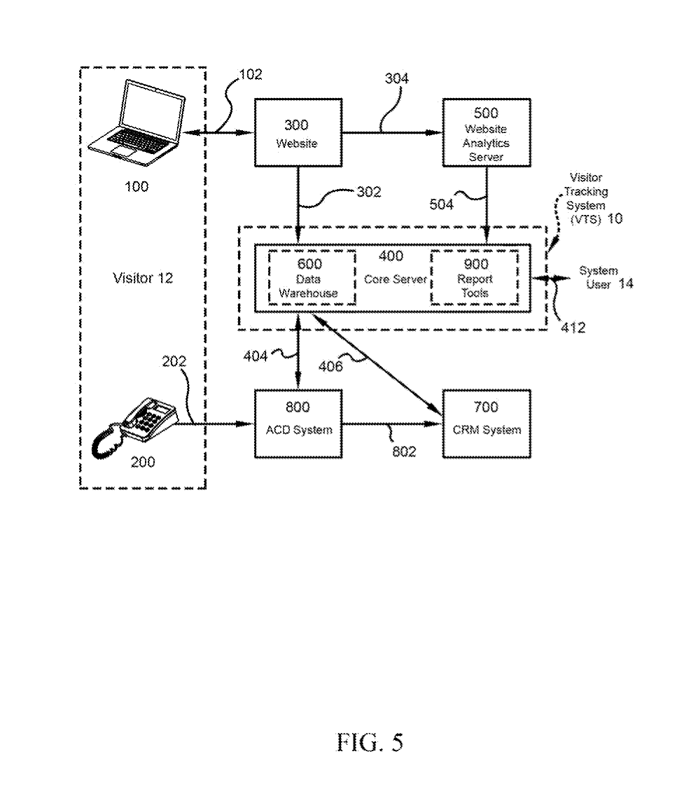

FIG. 5 is another diagram of major system components of an alternative exemplary Visitor Tracking System (VTS) 10 that differs from the VTS 10 embodiment of FIG. 4. The VTS 10 of FIG. 5 has both the data warehouse 600 and the report tools 900 component are disposed internal to the core server 400. Hence, each of the external system components, the website 300, the website analytics server 500, the CRM system 700, and the ACD system 800 directly with the core server 400, and all communications between the core server 400 and the data warehouse 600 and/or the report tools 900 component are handled internally within the core server 400. As shown, the core server 400 communicates directly with the system user 14. Like with the previously described embodiments, visitor's web interfacing device 100 is used by a visitor 12 to access the internet and the exemplary website 300, and the visitor's calling device 200 may be used by the visitor/caller 12 to place a phone call. The visitor 12 communicates and/or interacts with this embodiment of the VTS 10 using one or more of, either web interfacing devices 100 or calling devices 200.

Communication arrow 412 is a two-way arrow depicting that information is exchanged between the core server 400 and the system user 14 in a manner similar to what is described with respect to communication arrow 902 in FIGS. 2, 3, and 4. This exemplary embodiment is provided as an example to illustrate a differing configuration for the VTS 10. As shown in FIG. 5, communication arrows 302, 304, and 504 are each one-way arrows depicting the flow of information from the respective component to the core server 400. It should be understood, however, that without departing from the spirit or scope of the invention, it is contemplated that one or more of communication arrows 302, 304, and 504 may be two-way arrows depicting the exchange of information between the core server 400 and the respective external components.

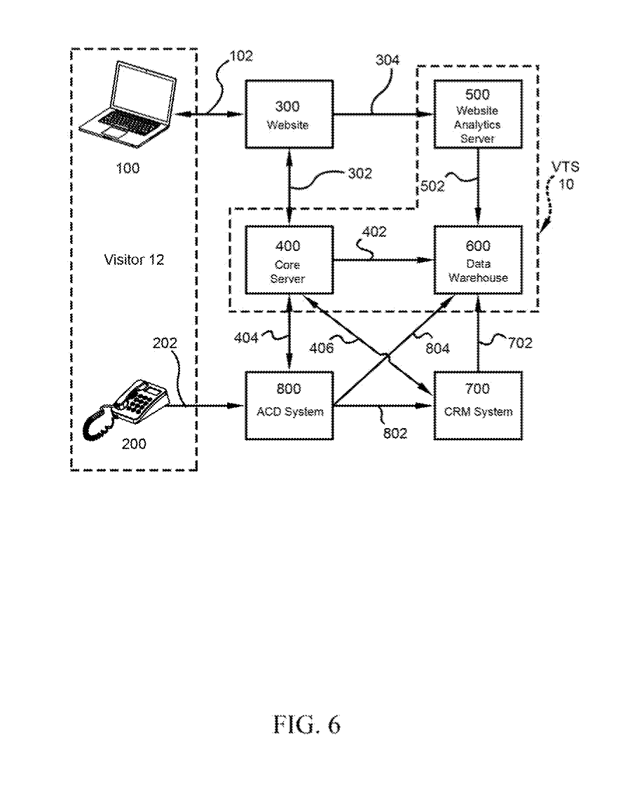

The alternative exemplary Visitor Tracking System (VTS) 10 of FIG. 6 is quite similar to the VTS 10 embodiment of FIG. 1, but differs in that the VTS 10 includes the core server 400, the website analytics server 500 and the data warehouse 600. Hence, the system user 14, whether an individual or a company, operates the VTS 10. Such operation may be the direct or indirect control of the core server 400, the website analytics server 500 and the data warehouse 600. The information flow paths represented by communication arrows 102, 202, 302, 304, 402, 404, 406, 502, 702, 802, and 804 are the same as the VTS 10 embodiment of FIG. 1. Again, the visitor's web interfacing device 100 is used by a visitor 12 to access the internet and the exemplary website 300, and the visitor's calling device 200 may be used by the visitor/caller 12 to place a phone call. The visitor 12 communicates and/or interacts with this embodiment of the VTS 10 using one or more of, either web interfacing devices 100 or calling devices 200.

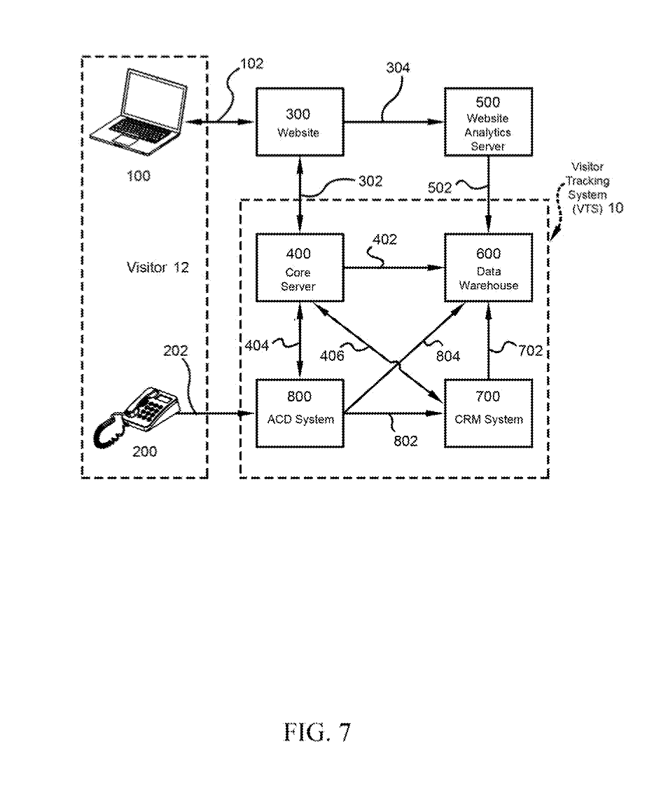

The alternative exemplary Visitor Tracking System (VTS) 10 of FIG. 7 is another embodiment that is quite similar to the VTS 10 embodiment of FIG. 1, but differs in that the VTS 10 includes the core server 400, the data warehouse 600, the CRM system 700, and ACD system 800. Hence, the system user 14, whether an individual or a company, operates the VTS 10. Such operation, in this instance, may be the direct or indirect control of the core server 400, the data warehouse 600, the CRM system 700, and ACD system 800. Again, the information flow paths represented by communication arrows 102, 202, 302, 304, 402, 404, 406, 502, 702, 802, and 804 are the same as the VTS 10 embodiment of FIG. 1. The visitor's web interfacing device 100 is used by a visitor 12 to access the internet and the exemplary website 300, and the visitor's calling device 200 may be used by the visitor/caller 12 to place a phone call. The visitor 12 communicates and/or interacts with this embodiment of the VTS 10 using one or more of, either web interfacing devices 100 or calling devices 200.

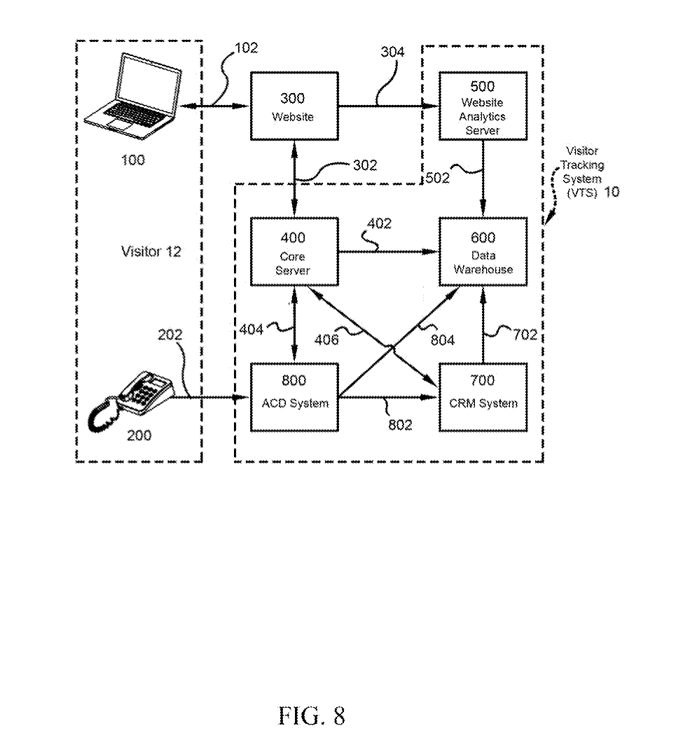

The alternative exemplary Visitor Tracking System (VTS) 10 of FIG. 8 is yet another embodiment that is quite similar to the VTS 10 embodiment of FIG. 1, but differs in that the VTS 10 includes the core server 400, the website analytics server 500, the data warehouse 600, the CRM system 700, and ACD system 800. Hence, the system user 14, whether an individual or a company, operates the VTS 10. Such operation, in this instance, may be the direct or indirect control of the core server 400, the website analytics server 500, the data warehouse 600, the CRM system 700, and ACD system 800. The information flow paths represented by communication arrows 102, 202, 302, 304, 402, 404, 406, 502, 702, 802, and 804 are the same as the VTS 10 embodiment of FIG. 1. Again, the visitor's web interfacing device 100 is used by a visitor 12 to access the internet and the exemplary website 300, and the visitor's calling device 200 may be used by the visitor/caller 12 to place a phone call. The visitor 12 communicates and/or interacts with this embodiment of the VTS 10 using one or more of, either web interfacing devices 100 or calling devices 200.

It should be understood that it is contemplated that each of the alternative embodiments depicted in FIGS. 6-8 can have the components and communication paths described and shown in FIGS. 2-5 without departing from the scope and spirit of the invention. Each of the exemplary embodiments contemplated by this paragraph are not specifically shown in drawings in the interest of brevity would be understood by those skilled in the art without further description.

Referring now to FIG. 9, the diagram depicted represents an exemplary process flow of a visit to website 300 by a visitor 12. At block 105, a visitor 12 has requested to view a webpage on website 300. The visitor 12 may have issued this request in any number of ways. For instance, the visitor 12 may have clicked on a link from a search engine, clicked on a paid search ad, clicked on a link from an email, or even typed the web address (URL) into a browser directly. At block 305, the website 300 receives the request and begins to process the request for the webpage the visitor 12 has requested. At block 310, the website 300 makes a request to the core server 400 of the VTS 10 to log the visit and retrieve a unique phone number to be displayed on the requested webpage 300. The same unique phone number is displayed on various webpages 300 visited by the visitor 12 throughout the visitor's session. Displaying during and throughout the visitor's session means that the same unique phone number is displayed on at least one or all webpages of the website, The website 300 passes pertinent data to the core server 400 of the VTS 10 including a unique visitor ID and the webpage 300 requested (URL). Also, the website 300 passes pertinent data to the core server 400 of the VTS 10 as the visitor 12 navigates the website 300 visiting various webpages.

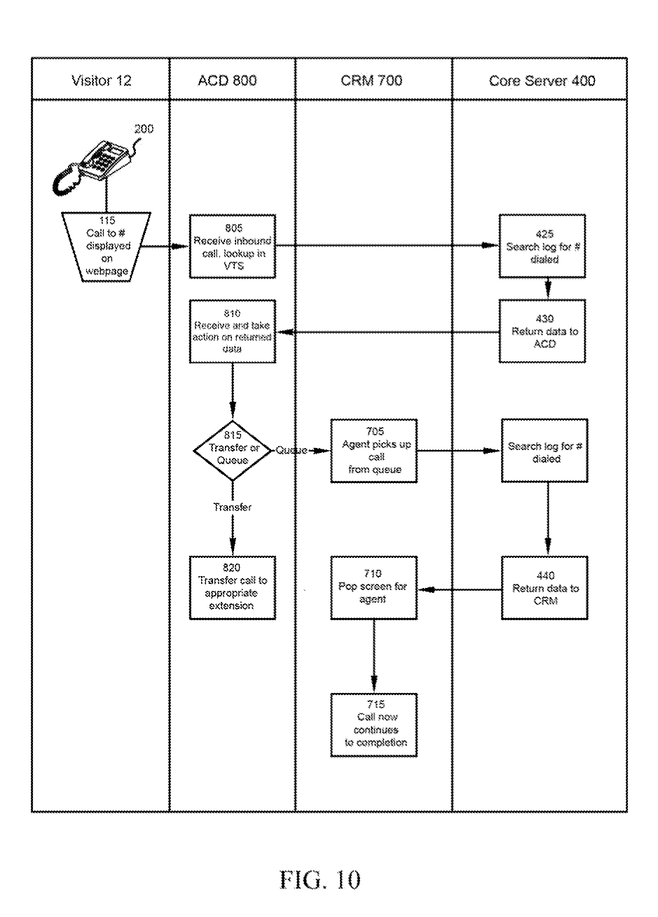

At block 405, the core server 400 of the VTS 10 receives the request and begins to process the request by first determining if the visitor 12 is a new visitor at diamond 410. If so, at block 415, a query for the next available unique number from a pool of unique numbers. The unique number is selected for display on the visitor's web interfacing device 100. The pool of phone numbers comprises a list of hundreds or thousands of unique phone numbers that have been provisioned for the system's use. The number of phone numbers necessary would depend on the peak number of visitors to the exemplary website 300 in a given time period. These numbers would all be provisioned to ring to the ACD system 800. As part of step 415, the logic of the VTS 10 ensures that once a number has been used, it is held for that specific visitor 12 for a predetermined minimum amount of time, usually several hours. If all of the unique numbers have been utilized and are being held for prior visitors 12 the VTS 10 would return a generic number. In this case, the visitor 12 could not be tracked but would not experience an adverse experience. The VTS 10 should notify system administrators that this occurred so that more unique numbers could be provisioned. At block 420, the VTS 10 logs the visitor 12 and the assigned unique number, the webpage visited and any other pertinent information to its database and/or the data warehouse 600. It then sends the assigned unique phone number to the website 300 for display. Then at block 315 website 300 sends the webpage with the unique phone number to the visitor's browser. At block 110, the visitor's browser displays the returned webpage. As part of the browser preparing the returned webpage to the visitor 12, a call is made to the web analytics server 500 to log the visitor's action at block 505. This process repeats for each subsequent webpage that visitor 12 views on the website 300. If the customer at any point picks up the phone (i.e., visitor calling device 200) and dials the number displayed, as depicted at keystone 115, the process in FIG. 10 would begin.

Referring now to FIG. 10, the diagram depicted represents an exemplary process flow of a visitor 12 that places a phone call to the unique number displayed on the website 300, as depicted at keystone 115. At block 805, the ACD system 800 would receive the inbound call from the visitor/caller 12 and then communicate with the VTS 10 to lookup the number that had been dialed to verify that the call was to the unique phone number that had been displayed on the website 30. The core server 400 of the VTS 10 would search the log for the phone number dialed at block 425 and would verify recent website activity involving the called number. If a match is found, the core server 400 will return appropriate data to the ACD system 800 with instruction on what action to take with the call, as depicted by block 430. The VTS 10 would also log the lookup step at block 425 for later analysis on visitor 12 calls.

At this point, the visitor/caller's 12 call has been linked to the visitor 12 website visit. The ACD system 800 at block 810 would receive the data returned from the core server 400 and would take action depending on the requirements of the business application. For instance, if the requirement was to send the call of the visitor/caller 12 to a specific employee, department or store based upon the webpage the visitor 12 viewed, this action would take place at decision diamond 815 and a transfer of the call would be made to the appropriate extension as shown at block 820. Otherwise, the call may be placed into a call center queue associated with the CRM system 700. At block 705, a call center agent picks up a call from the queue from within the CRM system 700, and the CRM system makes 700 communicates with the VTS 10. The core server 400 of the VTS 10 searches the log for the phone number dialed at block 435 and determines if there has been any recent website activity related to the called number. If a match is found, the core server 400 will return appropriate data to the CRM system 700 as shown by block 440 and instructs the CRM system 700 on what action to take with the call. The VTS would in addition log this lookup for later analysis on visitor calls. At block 710, the CRM system 700 receives data from the core server 400 of the VTS 10 and takes whatever action is required by business rules. For instance, based on the webpage the visitor/caller 12 visited, the CRM system may “pop” a particular screen for the agent, as depicted at block 710, to assist the agent in responding to any inquiries from the visitor/caller 12 during the call. The call would complete as normal as depicted at block 715. In this manner, a call from a visitor/caller 12 is handled seamlessly that makes the call appear to have been answered by a person without encountering a frustrating tree of automated exchanges. The visitor/caller 12 is directed to a person who is equipped to answer the questions or deal with the transactions desired by the visitor/caller 12.

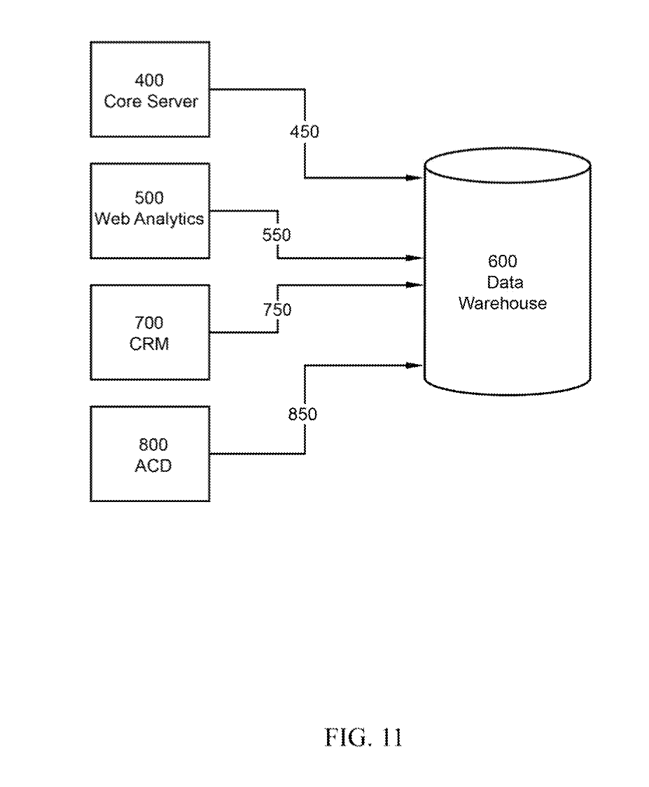

FIG. 11 is another diagram and represents an exemplary data flow of information collected from the various system components into a centralized data warehouse 600. The data flow at communication arrow 450 represents the movement of data collected during all of the processes previously described and is sent from the core server 400 to the data warehouse 600. This would include detailed logs of various visitors' webpage views and the phone numbers assigned (see FIG. 9), and detailed logs of visitor/callers 12 from both an ACD system 800 and CRM system 700 via communication arrows 850 and 750, respectively (see FIG. 10). Each of these records have unique log IDs for each visitor/caller 12 call. The data flow depicted by communication arrow 550 represents the movement of the detailed clickstream data from the web analytics server 500 into the data warehouse 600. The clickstream is the detailed output of the data collected by the web analytics server 500 at a level of one record per action or click on the website 300. Each of these records contains a unique visitor ID for each visitor 12. The data flow at communication arrow 750 represents the movement of the detailed call log data from the CRM system 700. This would include the detailed call record information including the result of the call (did the customer buy, or was their problem/question resolved), as well as the associated VTS 10 log ID for the visitor/caller 12. The data flow at communication arrow 850 represents the movement of the detailed CDR (call detail record) information from the ACD system 800. Exemplary data elements would include call from and to numbers, call length, call agent answering the call, how the call was routed and the associated VTS 10 log ID for the visitor/caller 12. By combining all of the described data into one repository, the various exemplary analyses can be performed. For example, marketing campaign attribution can be determined, i. e, giving value to individual marketing campaigns based on results of both online and offline visitor 12 actions. Website optimizations can be assessed by understanding visitor behavior and comparing visitor behavior to desired behavior. Also, changes can be made and then tracked to measure success.

Of course, it should be understood, that the information flow diagrams of FIG. 9-11 are depictions of an exemplary information flow and other information flows are contemplated. Those skilled in the art will understand that the VTS 10 may have many different configurations, several examples of which are described herein above. Differing configurations may slightly change how the information flows. For example, the diagrams of FIGS. 9-11 do not show the flow of information involving a report tool 900 or how a system user 14 would access analytics from the VTS 10. However, the altered flows of such information to accommodate differing configurations and additional components can be made by those skilled in the art when armed with the disclosure of this invention and without departing from the scope and spirit of the invention.

Those skilled in the art will appreciate that the present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A tracking system that interacts with a website and, at least one of a CRM system and an ACD System to correlate a visitor's online visit session to the website with a telephone contact made by the visitor, comprising:
an integration code within the website;
a core server that receives visit-related information sent by the integration code within the website and assigns a unique telephone number to the visitor to identify a visitor session, the unique telephone number is displayed on the website during the visitor session;
a data warehouse for receiving information from the core server and, at least one of the CRM system and the ACD system, the information received by the data warehouse comprising visit-related information and call-related information, the data warehouse analyzes the visit-related information and the call-related information and correlates the visitor session to the telephone contact to create correlated information.

2. The tracking system of claim 1, wherein the data warehouse is disposed within the core server.

3. The tracking system of claim 1 further comprising a report tools component, the report tools component communicates with the data warehouse and creates visitor session metrics from the correlated information.

4. The tracking system of claim 1 wherein the data warehouse extracts call-related information from the CRM system.

5. The tracking system of claim 4 wherein the CRM system extracts call-related information from the ACD system.

6. The tracking system of claim 1 wherein the data warehouse extracts call-related information from the ACD system.

7. The tracking system of claim 1 wherein the data warehouse extracts visit-related information from a website analytics server.

8. The tracking system of claim 7 wherein the website analytics server receives visit-related information from the website.

9. The tracking system of claim 1 wherein the core server has a pool of the unique telephone numbers from which the unique telephone number is selected and displayed on the website during and throughout the visitor session.

10. The tracking system of claim 9 wherein the unique telephone number selected and displayed on the website during the visitor session is returned to the pool a predetermined period of time after the visitor session has concluded.

11. A tracking system that interacts with a website and a telephone call-receiving system to correlate a visitor's online visit session to the website with a telephone contact made by the visitor, comprising:
an integration code within the website;
a website analytics server that receives visit-related information from the website;
a core server that receives visit-related information sent by the integration code within the website and assigns a unique telephone number to the visitor to identify a visitor session, the unique telephone number is displayed on the website during and throughout the visitor session;
a data warehouse for receiving information from the core server and the telephone call-receiving system, the information received by the data warehouse comprising visit-related information and call-related information, the data warehouse analyzes the visit-related information and the call-related information and correlates the visitor session to the telephone contact to create correlated information.

12. The tracking system of claim 11, wherein the data warehouse is disposed within the core server.

13. The tracking system of claim 11 further comprising a report tools component, the report tools component communicates with the data warehouse and creates visitor session metrics from the correlated information.

14. The tracking system of claim 11 wherein the core server has a pool of the unique telephone numbers from which the unique telephone number is selected and displayed on the website during the visitor session.

15. The tracking system of claim 14 wherein the unique telephone number selected and displayed on the website during the visitor session is returned to the pool a predetermined period of time after the visitor session has concluded.

16. A tracking system that interacts with a website and correlates a visitor's online visit session to the website with a telephone contact made by the visitor, comprising:
an integration code within the website;
a website analytics server that receives visit-related information from the website;
a core server that receives visit-related information sent by the integration code within the website and assigns a unique telephone number to the visitor to identify a visitor session, the unique telephone number is displayed on the website during and throughout the visitor session;
an ACD system that receives the telephone contact and generates call-related information;
a data warehouse for receiving information from the core server and the ACD system, the information received by the data warehouse comprising visit-related information and call-related information, the data warehouse analyzes the visit-related information and the call-related information and correlates the visitor session to the telephone contact to create correlated information.

17. The tracking system of claim 16 wherein the data warehouse is disposed within the core server.

18. The tracking system of claim 16 further comprising a report tools component, the report tools component communicates with the data warehouse and creates visitor session metrics from the correlated information.

19. The tracking system of claim 16 further comprising a CRM system, the ACM system transfers the telephone contact to the CRM system and the CRM system generates call-related information.

20. A method for correlating online visitor sessions from users' web interfacing devices with telephone contacts from users' calling devices, comprising :
receiving a request to view a webpage from one of the users' web interfacing devices;
assigning a unique telephone number to said visitor to identify a visitor session;
transmitting the requested webpage along with the unique telephone number to said user device;
receiving a telephone call directed to the unique telephone number; and
associating the telephone call with the visitor session.

21. The method for correlating online visitor sessions of claim 20 further comprising the step of sending website-visit information and call-related information related to the visitor session to a data warehouse for correlation.

22. The method for correlating online visitor sessions of claim 21 further comprising the step of withdrawing analytics relating to website-visit information and call-related information as correlated.
